(19) United States
(12) Patent Application Publication
(10) Pub. No.: US 2025/0321790 A1
(43) Pub. Date: Oct. 16, 2025

(54) METHOD FOR ARTIFICIAL INTELLIGENCE MODEL-BASED TASK MANAGEMENT AND SYSTEM THEREFOR

(71) Applicant: SAMSUNG SDS CO., LTD., Seoul (KR)

(72) Inventors: Sung Won CHO, Seoul (KR); Ji Hye LEE, Seoul (KR); In Hye JUNG, Seoul (KR); Ji Seon CHOI, Seoul (KR); Hye Jin BAE, Seoul (KR)

(73) Assignee: SAMSUNG SDS CO., LTD., Seoul (KR)

(21) Appl. No.: 19/076,541

(22) Filed: Mar. 11, 2025

(30) Foreign Application Priority Data
Apr. 11, 2024 (KR) 10-2024-0048410
May 29, 2024 (KR) 10-2024-0069812

(51) Int. Cl. G06F 9/50; G06F 21/10

(52) U.S. Cl. CPC G06F 9/5005; G06F 21/1077

(57) ABSTRACT

A method for task management and a system therefor are provided. The method according to some embodiments may include generating a task list by inputting user information of a user into a first model, the task list including a plurality of tasks expected to be processed by the user, generating a plurality of items related to the plurality of tasks by inputting the user information into the first model, receiving, from the user, a selection of a task to be processed by the user from among the plurality of tasks, receiving, from the user, a selection of an item related to the selected task from among the plurality of items, composing a first prompt by inputting the selected item into a second model, the first prompt requesting the selected task to be processed based on the selected item and outputting a processing result for the selected task by inputting the first prompt into a third model.

### CROSS-REFERENCE TO RELATED APPLICATIONS

This application claims priority from Korean Patent Application No. 10-2024-0048410 filed on Apr. 11, 2024, and Korean Patent Application No. 10-2024-0069812 filed on May 29, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and a system for an artificial intelligence (AI) model-based task management, and more specifically, to a method and an apparatus for generating and/or processing a task based on generative AI.

### 2. Description of the Related Art

With the advancement of artificial intelligence (AI) technology, generative AI has emerged as an AI system capable of generating various forms of media content, such as text and images, based on large-scale datasets.

Today, generative AI is being introduced and utilized across various industries to meet diverse and complex user demands. For example, in the past, collecting, analyzing, and/or extracting task-related data required significant time and human resources. However, in recent times, services have been provided that improve resource efficiency by utilizing generative AI, including ChatGPT, to perform related tasks.

However, in conventional task management methods utilizing generative AI, the services provided to ensure task execution efficiency have several issues. Users must directly search for or navigate to the necessary information and/or content. Additionally, managing vast amounts of accumulated task information (e.g., task-related history information) across multiple channels is difficult. Furthermore, users must manually compose prompts for task management (e.g., task generation or task processing). These issues lead to decreased efficiency in task execution and increased inconvenience for users.

Accordingly, a novel approach is required for AI-based task management to address these problems.

### SUMMARY

An objective of the present disclosure is to provide a method that enables a user to efficiently manage a task without having to manually compose a prompt.

The objectives of the present disclosure are not limited to those mentioned above. Other objectives, which are not explicitly stated, will be apparent to those skilled in the art based on the following description.

According to an aspect of the present disclosure, there is provided a method for task management performed by a computing device. The method may include generating a task list by inputting user information of a user into a first model, the task list including a plurality of tasks expected to be processed by the user, generating a plurality of items related to the plurality of tasks by inputting the user information into the first model, receiving, from the user, a selection of a task to be processed by the user from among the plurality of tasks, receiving, from the user, a selection of an item related to the selected task from among the plurality of items, composing a first prompt by inputting the selected item into a second model, the first prompt requesting the selected task to be processed based on the selected item and outputting a processing result for the selected task by inputting the first prompt into a third model.

In some embodiments, the method may further include receiving, from the user, a selection of at least one item from among the plurality of items, generating a task by inputting the at least one selected item into a fourth model and adding the generated task to the task list.

In some embodiments, the selected item may be a first item, the method may further include receiving, from the user, an input of a second item which is different from the first item and is related to the selected task, and the composing the first prompt may include composing the first prompt by additionally inputting the second item into the second model.

In some embodiments, wherein the receiving the input of the second item related to the selected task may include performing security or license authentication for the second item.

In some embodiments, the outputting the processing result for the selected task may include determining a completion status of the selected task; and performing security or license authentication for the processing result.

In some embodiments, the generating the task list may include storing generation-related information for the plurality of tasks in a first database, and the generating the plurality of items may include storing generation-related information for the plurality of items in a second database.

In some embodiments, the outputting the processing result for the selected task may include storing task processing information for the selected task in a third database.

In some embodiments, the outputting the processing result for the selected task may include generating a first generated product for the selected task by combining the selected item, and the method may further include receiving, from the user, a selection of the first generated product and at least some of the plurality of items and generating a second generated product corresponding to the selected task by inputting the at least some selected items into the second model and recombining the first generated product with the at least some selected items, using a result output from the second model.

In some embodiments, the method may further include displaying history information related to the selected task, the history information related to the selected task may include an item used for creating a generated product corresponding to the selected task and version information of the generated product corresponding to the selected task.

According to another aspect of the present disclosure, there is provided a system for task management. The system may include at least one processor and at least one memory configured to store instructions that, when executed by the at least one processor, cause the at least one processor to perform operations, wherein the operations may include generating a task list by inputting user information of a user into a first model, the task list including a plurality of tasks expected to be processed by the user, generating a plurality of items related to the plurality of tasks by inputting the user information into the first model, receiving, from the user, a selection of a task to be processed by the user from among the plurality of tasks, receiving, from the user, a selection of an item related to the selected task from among the plurality of items, composing a first prompt by inputting the selected item into a second model, the first prompt requesting the selected task to be processed based on the selected item and outputting a processing result for the selected task by inputting the first prompt into a third model.

In some embodiments, the operations may further include receiving, from the user, a selection of at least one item from among the plurality of items, generating a task by inputting the at least one selected item into a fourth model and adding the generated task to the task list.

In some embodiments, the selected item is a first item, the operations may further include receiving, from the user, an input of a second item which is different from the first item and is related to the selected task, and the composing the first prompt may include composing the first prompt by additionally inputting the second item into the second model.

In some embodiments, the receiving the input of the second item related to the selected task may include performing security or license authentication for the second item.

In some embodiments, the outputting the processing result for the selected task may include determining a completion status of the selected task; and performing security or license authentication for the processing result.

In some embodiments, the generating the task list may include storing task generation-related information for the plurality of tasks in a first database, and the generating the plurality of items may include storing item generation-related information for the plurality of items in a second database.

In some embodiments, the outputting the processing result for the selected task may include storing task processing information for the selected task in a third database.

In some embodiments, the outputting the processing result for the selected task may include generating a first generated product for the selected task by combining the selected item, and the operations may further include receiving, from the user, a selection of the first generated product and at least some of the plurality of items and generating a second generated product corresponding to the selected task by inputting the at least some selected items into the second model and recombining the first generated product with the at least some selected items, using a result output from the second model.

In some embodiments, the operations may further include displaying history information related to the selected task, and the history information related to the selected task includes an item used for creating a generated product corresponding to the selected task and version information of the generated product corresponding to the selected task.

According to yet another aspect of the present disclosure, there is provided a non-transitory computer-readable recording medium storing a computer program, which, when executed by at least one processor, causes the at least one processor to perform generating a task list by inputting user information of a user into a first model, the task list including a plurality of tasks expected to be processed by the user, generating a plurality of items related to the plurality of tasks by inputting the user information into the first model, receiving, from the user, a selection of a task to be processed by the user from among the plurality of tasks, receiving, from the user, a selection of an item related to the selected task from among the plurality of items, composing a first prompt by inputting the selected item into a second model, the first prompt requesting the selected task to be processed based on the selected item and outputting a processing result for the selected task by inputting the first prompt into a third model.

### BRIEF DESCRIPTION OF THE DRAWINGS

The above and other aspects and features of the present disclosure will become more apparent by describing exemplary embodiments thereof in detail with reference to the attached drawings, in which:

FIG. 1 illustrates an exemplary system according to an embodiment of the present disclosure;

FIG. 2 is a flowchart illustrating a method for task management according to an embodiment of the present disclosure;

FIG. 3 is a flowchart illustrating a method for task management according to another embodiment of the present disclosure;

FIG. 4 is a flowchart illustrating an example of how to compose a prompt requesting task processing according to some embodiments of the present disclosure;

FIG. 5 is a flowchart illustrating an example of how to output a task processing result according to some embodiments of the present disclosure;

FIG. 6 is a flowchart illustrating an example of how to generate a task and one or more task-related items according to some embodiments of the present disclosure;

FIG. 7 is a flowchart illustrating another example of how to output a task processing result according to some embodiments of the present disclosure;

FIGS. 8 and 9 illustrate interfaces for explaining tasks generated according to some embodiments of the present disclosure;

FIGS. 10 and 11 illustrate interfaces for composing a prompt to request task processing according to some embodiments of the present disclosure;

FIG. 12A and FIG. 12B illustrate an interface for task generation according to some embodiments of the present disclosure;

FIGS. 13 through 15 illustrate interfaces for providing generated items and related history information according to some embodiments of the present disclosure; and

FIG. 16 illustrates an exemplary computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In the present disclosure, “/” and “,” should be interpreted as representing “and/or.” For example, “A/B” and “A, B” may mean “A and/or B.”

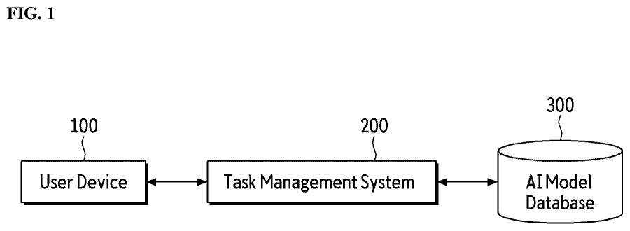

FIG. 1 illustrates an exemplary system according to an embodiment of the present disclosure.

Referring to FIG. 1, the system may include a user device 100, a task management system 200, and/or an artificial intelligence (AI) model database 300. Additionally, the system may provide a framework for performing one or more methods and/or operations according to some embodiments of the present disclosure using one or more models included in the AI model database 300.

The user device 100 may include various devices that a user employs to transmit and receive various types of data and/or information through communication with other devices. For example, the user may be a person who receives a task management service according to a method for task management of the present disclosure. The user device 100 may include a smartphone, a tablet PC, or a laptop, but is not limited to. For example, the user device 100 may include various computing devices equipped with wireless communication means and/or computing capabilities. The user device 100 may also be referred to as a wireless device, a mobile terminal, or a portable device.

The user device 100 may be used to utilize the task management system 200. For example, the user may perform task generation and/or task processing using the user device 100. In another example, the user device 100 may perform task generation and/or task processing without a user request according to some embodiments of the present disclosure. Additionally, the user device 100 may display a user interface for an application in which functions of task management system 200 are implemented, according to some embodiments of the present disclosure.

In the present disclosure, requests from the user input into an AI-based model may be collectively referred to as user requests. For example, a user request may include a request input through an application according to some embodiments of the present disclosure or a prompt input by a user. In the present disclosure, the AI-based model may refer to a generative AI-based model trained on various types of text, and the application may refer to a generative AI-based application. In the following description, unless otherwise stated, AI is assumed to represent generative AI.

The task management system 200 may perform one or more operations for task management according to some embodiments of the present disclosure, such as task generation and task processing, using one or more models included in AI model database 300. Additionally, the task management system 200 may be implemented on at least one computing device. For example, all functions of the task management system 200 may be implemented on a single computing device. In another example, some of the functions of the task management system 200 may be implemented on a first computing device, and the remaining functions may be implemented on a second computing device. Additionally, a specific function of the task management system 200 may be implemented on one or more computing devices. In another example, the task management system 200 may be configured using one or more physical servers.

The AI model database 300 may include at least one AI-based model according to some embodiments of the present disclosure. Here, the AI-based model may refer to a generative AI-based model. In the present disclosure, the AI-based model may also be referred to as a large-scale language model (LLM), a generative AI model, a question-answering model, or a conversational model depending on its implementation and/or operation.

The components illustrated in FIG. 1 may communicate via various types of wired and/or wireless networks. Apparatuses and/or systems according to the present disclosure may be applicable to a local area network (LAN), a wide area network (WAN), a mobile radio communication network, Wireless Broadband Internet (WiBro), and other arbitrary communication systems without limitation.

Conventional methods, devices, and/or systems utilizing generative AI suffer from low resource efficiency and user convenience because users must manually input prompts via a keypad to send a generation request. For example, users must compose prompts by manually entering full text via a keypad on a small mobile screen. Additionally, users must search for or navigate to the necessary input materials for generation, enter a prompt, and wait for the generation to complete before obtaining the generated content. Furthermore, users cannot check previous versions of the generated content or verify the materials used for the generation, which leads to significant consumption of labor and time resources.

To address these problems, the present disclosure provides AI model-based task management methods, apparatuses, and/or systems. By automatically collecting and analyzing data related to the user's task activities, using generative AI technology, the task management methods, apparatuses, and/or systems according to the present disclosure aim to generate an efficient task history, provide items for task processing (also referred to as task execution), and ultimately achieve complete automation of all tasks, thereby enhancing user task efficiency.

Although not illustrated in FIG. 1, the system may further include a database. For example, although not illustrated in FIG. 1, the system may further include a database for storing input/output data of one or more models included in AI model database 300. For example, the system may further include a first database for storing information related to a task list generated according to some embodiments of the present disclosure. In another example, the system may further include a second database for storing information related to items generated according to some embodiments of the present disclosure. In yet another example, the system may further include a third database for storing results of processing tasks according to some embodiments of the present disclosure.

In the present disclosure, task-related items may refer to various types of content such as text, video, and images and may be content generated based on generative AI. These items may be used for combining or regenerating existing tasks, creating new tasks, or processing existing or new tasks. In the present disclosure, task-related items may also be referred to as materials, generation materials, generated content, generated products, or material elements.

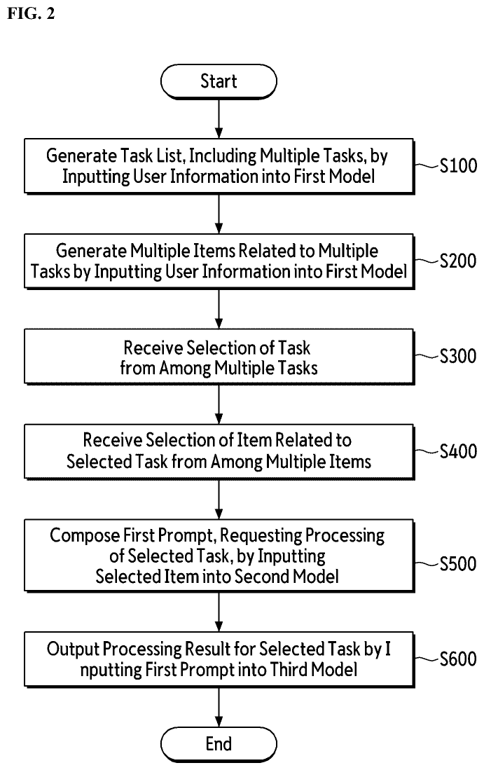

Examples in which a computing device performs AI model-based task management according to embodiments of the present disclosure will hereinafter be described with reference to FIGS. 2 through 7. FIGS. 2 through 7 illustrate steps/operations performed by the task management system 200 in FIG. 1. Accordingly, in the following description, if the subject performing a specific step/operation is omitted, it may be understood that the specific step/operation is performed by the task management system 200 in FIG. 1. The description below references FIGS. 1 and 2 along with FIGS. 2 through 7.

FIG. 2 is a flowchart illustrating a method for task management according to an embodiment of the present disclosure.

Referring to FIG. 2, a computing device may generate a task list by inputting user information into a first model (S100). The task list may include a plurality of tasks expected to be performed by the user. Here, the first model may be a model for generating tasks and/or items.

The user information may include all information related to the user, such as personal information, information on services in use, information on services not in use, and internal or external information associated with the user. Specifically, the personal information may include the user's basic identification information, usage history, usage patterns, and needs. The information on services in use may include data from services (e.g., collaboration tools, messengers, email, SNS, etc.) currently used by the user, such as meeting records, messenger logs, email logs, shopping records, map history, SNS records, and financial information. The information on services not in use may include information on services that are not being in use by the user but contain data necessary for generating generative AI results. The external information may refer to external data related to the user or external data required for generating generative AI results. According to some embodiments of the present disclosure, the external information may automatically pass through a compliance server to be utilized for AI-based task management, if safe.

In other words, in step S100, tasks expected to be performed by the user may be automatically generated in advance based on the user information, such as usage history, usage patterns, and needs, and may then be recommended to the user. That is, according to step S100, a prompt requesting task generation may be composed using the user information without requiring the user's prompt text key-in, and a response from the first model may be output for the composed prompt.

In the present disclosure, task generation refers to generating a task and/or a list of tasks that the user is expected to perform based on the user information using generative AI. Furthermore, task generation may also involve generating a task and/or a list of tasks and processing (or executing) the task(s) to create a corresponding generated product, such as a document or video, for immediate usability.

Thereafter, the computing device may generate a plurality of items related to a plurality of tasks by inputting the user information into the first model (S200). As described above, the items may refer to various types of content, such as text, videos, and images. Additionally, the items may include materials according to some embodiments of the present disclosure and may also be referred to as materials, generation materials, generated content, generated products, or material elements.

For example, in step S200, the computing device may generate materials necessary for composing a prompt requesting task processing, executing tasks, or generating new tasks, may predict and generate content tailored to the user's needs based on the user's personalized information, may create history information of generated tasks, generated materials, and/or generated content (e.g., generation records, information on the materials used for generation, version information, etc.), or may generate a summarized daily task record.

Thereafter, the computing device may receive a selection of a task that the user intends to process from among the plurality of tasks included in the task list (S300) and receive a selection of an item related to the selected task from among the plurality of items (S400).

Additionally, the computing device may compose a first prompt (S500) that requests the selected task from step S300 to be processed based on the selected item from step S400, by inputting the selected item into a second model, and may output a processing result for the selected task by inputting the first prompt into a third model (S600). Here, the second model may be a model for composing a prompt requesting task processing, and the third model may be a model for task processing/execution. The processing result may refer to the generated product obtained as a result of executing or processing the selected task, such as a document, video, image, or other content.

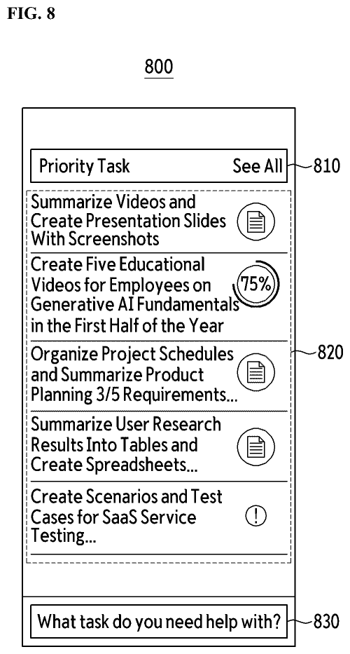

Furthermore, the task list, automatically collected task records, and items from steps S100, S200, S300, S400, S500, and S600 may be provided to the user through widgets. The details regarding the generation and provision of a task list, task records, and material elements (i.e., items) for prompt input in the form of widgets will be described later with reference to FIGS. 8 through 15.

As illustrated in FIG. 1, the present disclosure focuses on utilizing generative AI to automatically collect and analyze user information, such as personal information and task-related data, to recommend tasks based on the user's needs. The present disclosure also aims to automatically link and/or summarize task histories across a variety of channels and utilize them to enhance the efficient use of task-related data. Specifically, referring to steps S100 and S200, the user information, including personal data obtained with the user's consent and data collected from task services, may be integrated to analyze the user's task patterns and requirements. Based on this analysis, tasks expected to be performed by the user may be automatically generated, and the content required by the user (i.e., processing results for the expected tasks) may also be predicted, generated, and provided. Additionally, referring to steps S300, S400, S500, and S600, the present disclosure may generate and provide material elements for prompt input using generative AI, enabling the user to efficiently create necessary information.

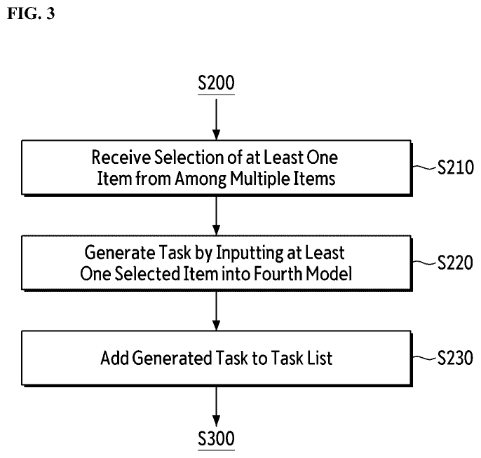

FIG. 3 is a flowchart illustrating a method for task management according to another embodiment of the present disclosure.

Specifically, FIG. 3 illustrates another example of how to generate one or more tasks according to some embodiments of the present disclosure, in addition to the method for generating a task of FIG. 2.

Referring to FIG. 3, after generating a plurality of items related to a plurality of tasks included in a task list in step S200 of FIG. 2, the computing device may receive a selection of at least one item from among the plurality of items from the user (S210), and generate a task by inputting the at least one selected item into a fourth model (S220). Here, the fourth model may be a model for generating a new task that is not included in the task list generated by the first model in FIG. 2.

Thereafter, the computing device may add the task generated in S220 to the task list (S230) and may then perform steps S300, S400, S500, and S600 of FIG. 2 for task processing.

For example, if there is no automatically generated task based on the user information through a generative AI model (e.g., the first model), or if the user does not find a necessary task in the task list, the user may select at least one item from among a plurality of items generated through the generative AI model (e.g., the first model), thereby generating a new task. Even in this case, without the user's prompt text key-in, a prompt requesting task generation may be composed based on the selected item, and a response from another generative AI model (e.g., the fourth model) for the composed prompt may be output.

Referring to FIGS. 2 and 3, the task management methods, apparatuses, and/or systems according to embodiments of the present disclosure automatically generate tasks, task results, and items for composing prompts for task generation/processing based on a generative AI model. Accordingly, even if the user does not manually compose a prompt, task generation and/or task processing can be performed, thereby improving task execution efficiency and enhancing user convenience.

The procedures that follow steps S210, S220, and S230 in FIG. 3 may correspond to S300, S400, S500, and S600 in FIG. 2.

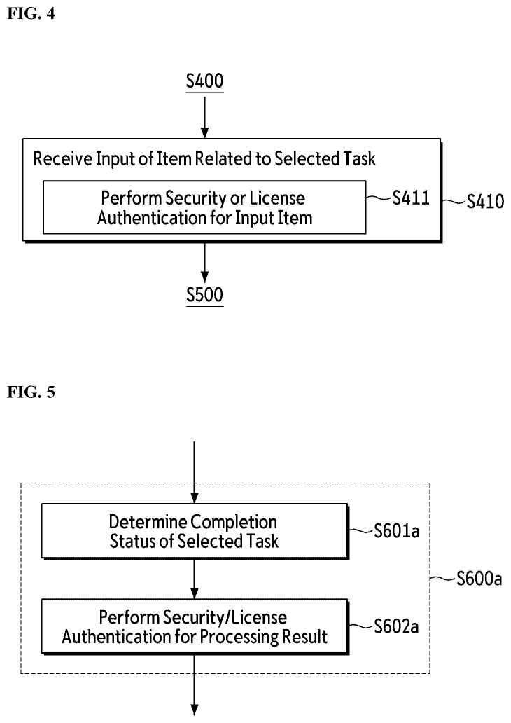

FIG. 4 is a flowchart illustrating an example of how to compose a prompt requesting task processing according to some embodiments of the present disclosure.

Specifically, FIG. 4 is a flowchart illustrating an exemplary method for receiving task-related items from the user to compose a prompt requesting task processing, as described in FIGS. 2 and 3.

Referring to FIG. 4, the computing device may receive input of one or more task-related items (S410) from the user for the task selected in S300 of FIG. 2, and may input the received items into the second model, thereby composing a first prompt corresponding to step S500 of FIG. 2. Here, the items received from the user are distinguished from the plurality of items automatically generated in step S400. That is, in order to compose the first prompt requesting task processing, the computing device may not only receive the user's selection from the plurality of items automatically generated based on the generative AI model but also directly receive item input from the user. Therefore, although steps S400 and S410 are illustrated in FIG. 4 as being sequential steps, the present disclosure is not limited thereto. For example, the computing device may perform step S400 and then step S410. In another example, the computing device may perform step S410 and then step S400. In yet another example, the computing device may perform only one of step S400 or step S410 to compose the first prompt.

Additionally, the computing device may perform security/license authentication (S411) for the received item from step S410. Furthermore, among the received items, only those verified as safe through the security/license authentication may be input into the second model in step S500, and the first prompt requesting task processing for the selected task may be composed.

The procedures that follow steps S410 and S411 in FIG. 4 may correspond to steps S500 and S600 in FIG. 2.

FIG. 5 is a flowchart illustrating an example of how to output a task processing result according to some embodiments of the present disclosure.

Specifically, FIG. 5 is a detailed flowchart illustrating an example of the step of outputting task processing results in FIG. 2. Step S600a in FIG. 5 may correspond to step S600 in FIG. 2.

Referring to FIG. 5, during the step of outputting the task processing result for the selected task, the computing device may determine whether the selected task has been completed (S601a). Here, determining the completion status of a specific task may refer to determining whether the processing of the specific task has been completed. The completion status of a specific task may be classified as complete, incomplete, and/or not initiated. For example, a specific task may be classified as not initiated if the processing of the specific task has not been completed, if there exists no relevant items for composing a prompt for processing the specific task, if no selection and/or input of items for composing a prompt for processing the specific task has been received from the user, if no prompt has been input into the third model for task processing, and/or if the specific task remains in a queue due to another task's generation/processing.

Additionally, in step S601a, the computing device may perform security/license authentication (S602a) for the processing result for the task determined to be complete in step S601. Steps S601a and S602a do not necessarily need to be performed sequentially and may be executed simultaneously. For example, after executing a prompt for the generation/processing of a task and determining whether the required products (or processing results) have been fully generated, if the generation of the required products (or processing results) is complete, any security and/or license violations may be verified via a compliance server upon the detection of an unauthorized data exposure for the task. Then, once security/license authentication is complete, the task may be deemed fully completed.

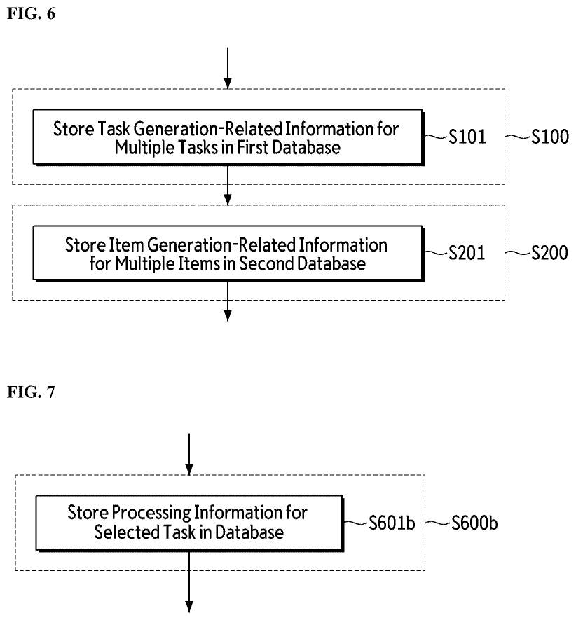

FIG. 6 is a flowchart illustrating an example of how to generate a task and one or more task-related items according to some embodiments of the present disclosure.

Specifically, FIG. 6 is a detailed flowchart illustrating an example of the step of generating a task and one or more task-related items in FIG. 2. Step S100 in FIG. 6 may correspond to step S100 in FIG. 2, and step S200 in FIG. 6 may correspond to step S200 in FIG. 2.

Referring to FIG. 6, during the step of generating a task list, the computing device may store task generation-related information for a plurality of tasks included in the task list in a first database (S101). The task generation-related information may refer to information associated with the generation of each of the plurality of tasks included in the task list. For example, the task generation-related information may include the creation date, creation record, task content, and task type (e.g., document, image, video, etc.) of each of the plurality of tasks included in the task list. The creation record of each of the plurality of tasks may include item information for each service (e.g., meeting, email, messenger, collaboration tool, etc.) that serves as the basis for the generation of the corresponding task, and user personal information. Thereafter, during the step of generating a plurality of items, the computing device may store item generation-related information for the plurality of items in a second database (S201). The item generation-related information may refer to information associated with the generation of each of the plurality of items. For example, the item generation-related may include the creation date, creation record, and version of each of the plurality of items. The creation record of each of the plurality of items may include item information for each service (e.g., meeting, email, messenger, collaboration tool, etc.) that serves as the basis for the generation of the corresponding item, and user personal information.

Here, the first database may correspond to the first database that may be included in the system of FIG. 1, as described with reference to FIG. 1, although not explicitly illustrated in FIG. 1. Similarly, the second database may correspond to the second database that may be included in the system of FIG. 1.

Through this, the user may be provided with a task list, generated tasks, generated materials, and/or history information of generated content (e.g., creation records, information on the materials used for generation, version information, etc.). Furthermore, the generated tasks may be provided as the generated materials and/or generated content (i.e., items).

FIG. 7 is a flowchart illustrating another example of how to output a task processing result according to some embodiments of the present disclosure.

Specifically, FIG. 7 is a detailed flowchart illustrating another example of the step of outputting a task processing result in FIG. 2. Step S600b in FIG. 7 may correspond to step S600 in FIG. 2.

Referring to FIG. 7, during the step of outputting the task processing result for the selected task, the computing device may store task processing information for the selected task in a third database (S601b). The task processing information may include the task processing result and history information (e.g., a processing record, information on the materials used for processing, version information, etc.) for the selected task. Here, the third database may correspond to the third database included in the system of FIG. 1.

Through this, the user may be provided with the history information for the selected task, such as the task processing result, information on the materials used for processing, version information, or a summarized daily task record.

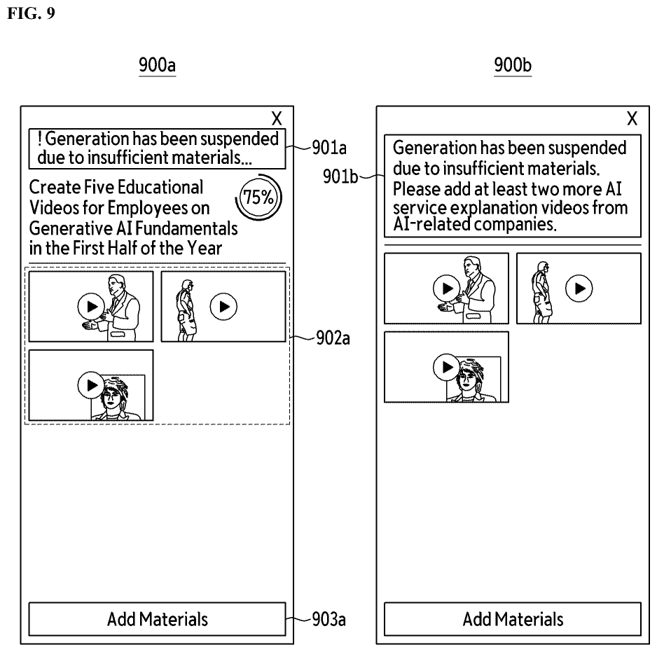

FIGS. 8 and 9 illustrate interfaces for explaining tasks generated according to some embodiments of the present disclosure.

Specifically, FIG. 8 illustrates a home interface 800 that includes a task list and/or one or more task processing results generated according to the methods for task management of FIGS. 2 through 7.

Referring to FIG. 8, the home interface 800 may include a task list 820 that has been automatically generated and/or processed using a generative AI model. The tasks included in the task list 820 may be provided to the user in the form of widgets. The generative AI model may learn and analyze user information (e.g., the user's personal information, information transmitted/received through service linkage, etc.), predict the user's needs and/or the importance of tasks based on the results of the analysis, generate one or more tasks, and provide the generated tasks and/or priority information of the tasks. For example, when the user accesses a generative AI mobile service providing a task management service according to some embodiments of the present disclosure, the user may be directed to the home interface 800 and may check/utilize a priority task list 820. Furthermore, the generative AI model may provide the results of processing (or executing) the generated tasks based on the learned and analyzed user information. For example, referring to FIG. 8, the task list 820, which is the list of tasks that have been generated/processed, may include information related to each of the tasks in text form and may include icons representing the completion status (e.g., complete, incomplete, and/or not initiated) of each of the tasks. For example, for tasks that are incomplete, the progress rate of task processing may be displayed. Once the generation/processing of the incomplete and/or not initiated tasks is complete, their respective icons may be updated to indicate that the tasks are complete.

The completion status of each task will hereinafter be described in further detail. A complete task refers to a task that has been fully processed, with its generated product (e.g., a document, video, or other content) immediately available for use. In this case, the user may click/tap the icon on the right side of the task list 820 to download the generated product. An incomplete task refers to a task that has not been fully processed due to a lack of necessary materials. In this case, the user may be notified of the reason for the incompletion of the task, and generative AI may assist the user in adding the required materials to complete the task. A not initiated task refers to a task that has not yet been processed by generative AI due to, for example, being in a queue behind other tasks. In this case, the user may be notified of the not initiated status of the task, and generative AI may assist the user in restarting or continuing the generation of the task through the adjustment of the required materials.

Additionally, the home interface 800 may further include a task list view button 810. The user may click/tap the task list view button 810 (e.g., a “See All” button) to check the full task list 820 generated based on the user's information by generative AI. According to embodiments of the present disclosure, generative AI ultimately performs task management to ensure that no tasks remain incomplete and/or not initiated.

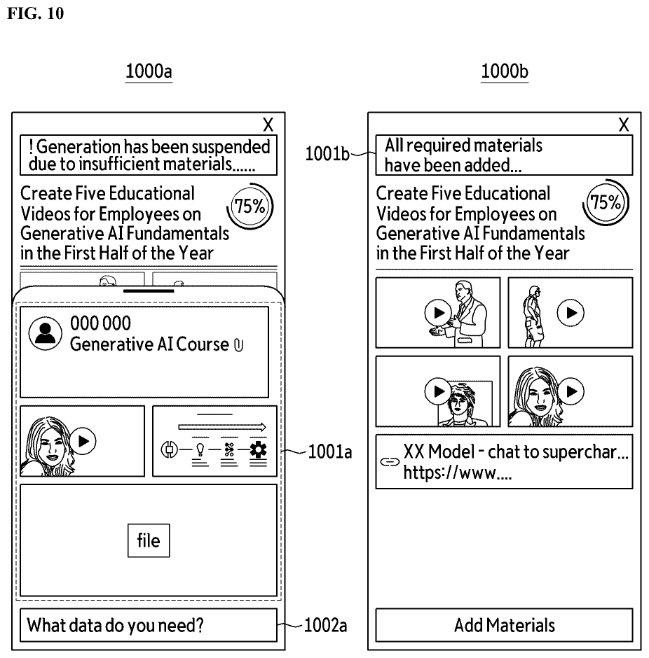

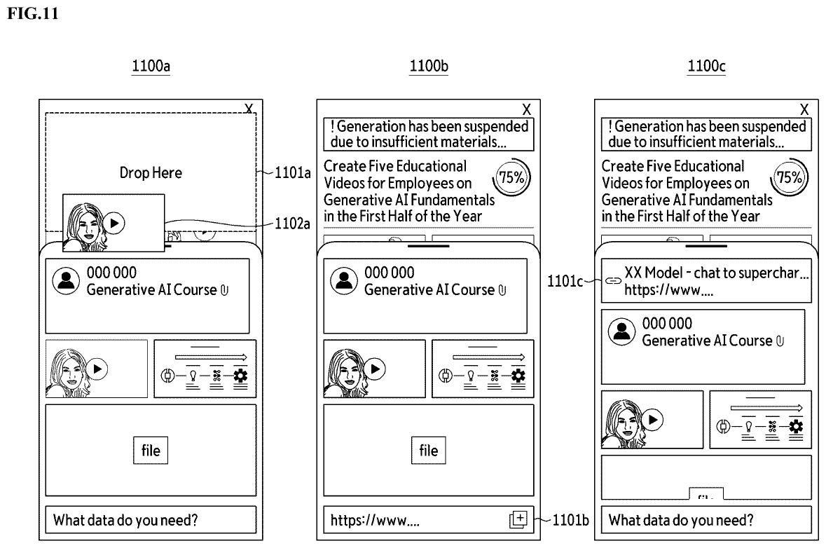

Furthermore, the home interface 800 may further include a material search area 830. If the user does not find a desired task in the task list 820, which is the list of tasks automatically generated/processed based on generative AI, the user may click/tap the material search area 830 to select one or more items for task generation. For example, when the user clicks/taps the material search area 830, the material search area 830 may expand and transition to a material selection screen for generating the user's task. The material selection screen will be described later with reference to FIG. 10.

In other words, in the home interface 800, one or more tasks expected to be performed by the user may be recommended and automatically generated based on the user information, including the user's usage history, patterns, needs, and service usage records.

Specifically, FIG. 9 illustrates processing results output according to the methods for task management of FIGS. 2 through 7 and shows interfaces displaying detail pages 900a and 900b for each task included in the task list 820 of FIG. 8.

Referring to FIG. 9, the detail pages 900a and 900b may include information regarding the content of a task and an icon indicating the task's completion status (e.g., complete, incomplete, and/or not initiated).

The detail pages 900a and 900b are screens that appear when the user clicks/taps one of the tasks in the task list 820 of FIG. 8. For example, when the user accessing the generative AI mobile service providing a task management service according to some embodiments of the present disclosure clicks/taps a task in the task list 820, the user may navigate to the detail page for the selected task.

Additionally, the detail pages 900a and 900b may include guidance messages 901a and 901b, a material list 902a, and/or an “Add Material” button 903a.

The guidance messages 901a and 901b include messages informing the user of the completion status of the selected task. FIG. 9 illustrates exemplary detail pages for an incomplete task, where the user may check the reason for the incompletion of the task through the guidance messages 901a and 901b. For example, when the user clicks/taps the guidance message 901a, which displays a portion of a message, the guidance message 901a may expand into the guidance message 901b, displaying the full message. For example, the message may indicate that generation of the selected task has been interrupted due to insufficient materials and that a certain number of additional materials/items are required.

The material list 902a includes a list of materials used as the basis for generating the selected task and/or a list of materials set for the generation of the selected task. FIG. 9 illustrates exemplary detail pages for an incomplete task, where the user may check the materials set for generating the selected task through the material list 902a. Each material included in the material list 902a may be added/removed as needed.

The “Add Material” button 903a, which is a button for adding materials to the material list 902a, may also be referred to as a material addition button, an “Add Item” button, or an item addition button, and may operate according to some embodiments of the present disclosure. For example, when the user selects and/or adds materials by clicking/tapping the “Add Material” button 903a, the generative AI model may complete the generation of the selected task based on the material list 902a, including the newly added materials.

The detail pages 900a and 900b, which are exemplary detail pages for an incomplete and/or not initiated task included in the task list 820, may or may not include the guidance messages 901a and 901b, the material list 902a, and/or the “Add Material” button 903a, depending on the selected task's completion status. For example, the detail page for a not initiated task may not include the material list 902a. In another example, the detail page for a completed task may not include the guidance messages 901a and 901b and/or the “Add Material” button 903a, but may further include the history information of the task (e.g., a creation record, information on the materials used for generation, version information, a summarized daily task record, etc.).

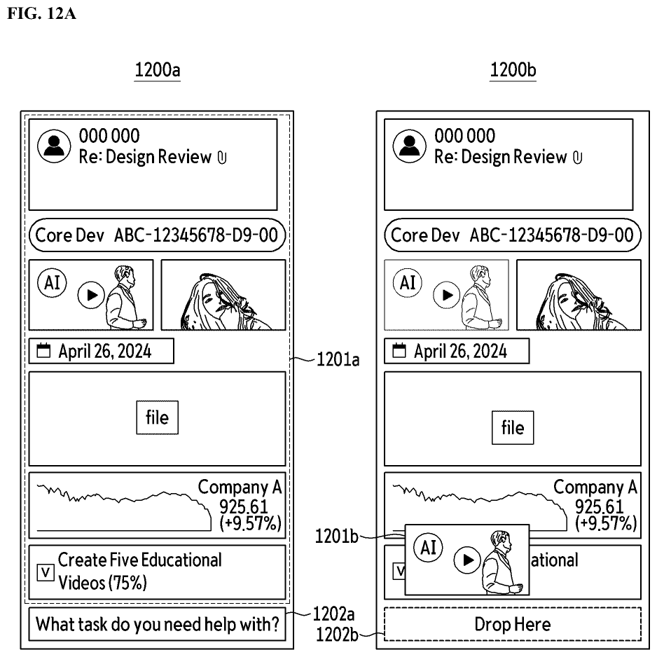

FIGS. 10 and 11 illustrate interfaces for composing a prompt requesting task processing according to some embodiments of the present disclosure.

Specifically, FIG. 10 illustrates a detail page 1000a for selecting and/or adding materials that serve as the basis for the generation of a task, and a detail page 1000b for a task in which materials selected and/or added by the user are included in the material list 902a in FIG. 9. For example, the user may navigate to the detail page 1000a by clicking/tapping the “Add Material” button 903a in FIG. 9.

Referring to FIG. 10, the detail page 1000a may include a material selection area 1001a and/or an input area 1002a for entering text.

The user may select and/or add materials in the material selection area 1001a for task generation/processing. The materials included in the material selection area 1001a may be provided in the form of widgets.

The user may enter text in the input area 1002a to search for desired materials from among the materials included in the material selection area 1001a or to filter only the desired materials. Additionally, the input area 1002a may allow the user to enter materials that are not included in the material selection area 1001a. For example, the user may search for, select, and/or add materials through the material selection area 1001a and/or the input area 1002a to complete the generation/processing of an incomplete task.

In the present disclosure, materials may also be referred to as generation materials, generated content, generated products, material elements, or items.

According to some embodiments of the present disclosure, materials may be generated and provided by generative AI in forms that reflect the characteristics of service data and user information, such as personal information. These materials may be generated in different forms (e.g., email, video, image, document, to-do item, etc.). Each material may be provided in the form of a widget, and upon clicking/tapping each material, other relevant content may be provided for the user. For example, when selecting/clicking/tapping a specific video, a list of related videos may be provided, allowing the user to select some or all of the related videos for use as additional materials.

Additionally, recommended/generated content, task generation/processing results, and other elements may all be included as materials according to some embodiments of the present disclosure.

According to some embodiments of the present disclosure, when the user adds materials, the added materials may be viewed in the detail page 1000b. The added materials may be included in a material list on the detail page 1000b and provided in the form of widgets. Additionally, according to some embodiments of the present disclosure, if the necessary materials for task generation/processing have been added and fully set up, a guidance message 1001b may be provided to notify the user of this status. For example, a message indicating that all required materials have been added and that task generation/processing will begin automatically may be displayed.

The detail page 1000b in FIG. 10 illustrates an exemplary detail page for an incomplete task for which the user has selected and/or added materials through the detail pages 900a and 900b in FIG. 9. The detail page 1000b in FIG. 10 may correspond to the detail page 900a and/or the detail page 900b in FIG. 9 and may also correspond to the guidance message 901a and/or the guidance message 901b in FIG. 9.

The operations of selecting and/or adding materials from the material selection area 1001a and entering and/or adding materials (e.g., external materials) that are not included in the material selection area 1001a through the input area 1002a will hereinafter be described in further detail with reference to FIG. 11.

Specifically, FIG. 11 illustrates a detail page 1100a for explaining the operation of selecting and/or adding recommended/generated materials based on generative AI, and detail pages 1100b and 1100c for explaining the operation of entering and/or adding materials other than the recommended/generated materials, for example, external materials. The detail pages 1100a through 1100c correspond to the detail page 1000a in FIG. 10.

Referring to FIGS. 10 and 11, the user may select one or more materials from a material selection area 1001a, which includes recommended/generated materials based on generative AI, and add the selected materials to a material list. For example, each material may be provided in the form of a widget, and the user may add a first material 1102a to the material list by dragging and dropping it in an upper part 1101a of the detail page 1100a.

Additionally, the user may add, to the material list, materials that are not included among the recommended/generated materials based on generative AI, by entering them in the input area 1101b. For example, the user may enter a URL for an external material (e.g., a video, an image, or other content) in the input area 1101b and click/tap the icon on the right side of the input area 1101b to add it as a URL-based material in the material list. Specifically, an added material 1101c may be included in a material selection area and provided in the form of a widget for the user. Finally, the user may drag and drop the added material 1101c into the material list. If the user enters external materials in the input area 1101b for addition, security/license authentication for the external materials may be performed. For example, when the user adds external materials, the compliance server may perform security/license authentication on the external materials to detect policy violations. Then, only safe materials may be added and utilized as materials.

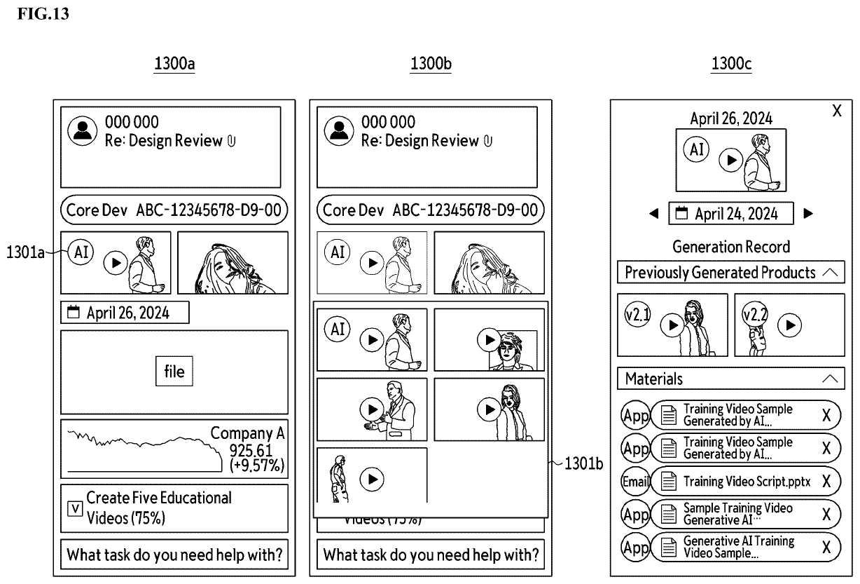

According to some embodiments of the present disclosure, material elements may be provided in the form of widgets to allow the user to generate a task without requiring a prompt text key-in, enabling the user to create a personalized prompt using these material elements. In other words, the task management methods, apparatuses, and/or systems according to the present disclosure provide advanced input elements (or material elements) that replace manual (or direct) prompt input from the user and utilize user-customized information, making them more sophisticated than keyword chips. Furthermore, the user may click/tap on each material element's widget to check the generation history of the corresponding material element (e.g., what material elements were used on specific dates for generation and previous version information for any combined/regenerated material elements). This will be described later in further detail with reference to FIG. 13.

FIGS. 10 and 11 describe embodiments with reference to incomplete tasks, but the present disclosure is not limited thereto. For example, the user may also add/input materials for not initiated tasks using interfaces corresponding to those illustrated in FIGS. 10 and 11.

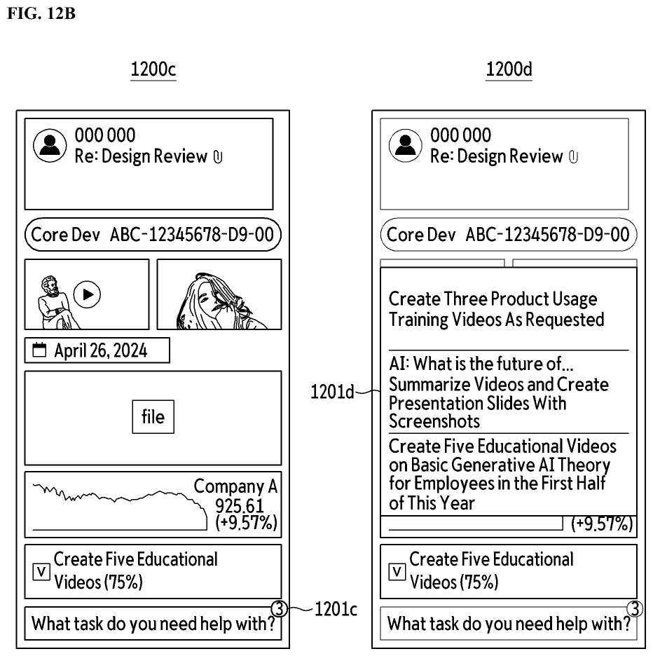

FIG. 12A and FIG. 12B illustrate an interface for task generation according to some embodiments of the present disclosure.

Specifically, FIG. 12A and FIG. 12B illustrate an interface for the step of generating one or more tasks in FIG. 3. FIG. 12 illustrates new task generation pages 1200a through 1200d, which are displayed when the user clicks/taps the material search area 830 in FIG. 9.

Referring to FIG. 12A and FIG. 12B, the new task generation page 1200a may include a material list 1201a containing recommended/generated materials for task generation and/or an input area 1202a for setting/adding materials for new task generation.

The materials included in the material list 1201a may be provided in the form of widgets. For example, if the user does not find a required task in the task list 820 included in the home interface 800 of FIG. 8, the user may drag a first material 1201b from the material list 1201a and drop it into a lower part 1202b of the new task generation page 1200b and/or into the input area 1202a, thereby directly setting the material list for new task generation/recommendation.

When the user sets the material list by adding materials, an icon 1201c may be generated in the upper right corner of the input area 1202a, indicating that materials have been added for new task generation. For example, the icon 1201c may display the number of added materials. When the user clicks/taps the icon 1201c, the user may view a task list 1201d that has been generated and recommended by generative AI according to some embodiments of the present disclosure, based on the set material list. Additionally, if a task has been generated based on the user-set material list but remains incomplete, the user may add more materials and proceed with task generation again according to the methods and/or operations described with reference to FIGS. 10 and 11.

The materials included in the material list 1201a may be generated products (or processing results) recommended by generative AI based on service data and personal information, and/or generated in a form (e.g., email, video, image, document, to-do item, etc.) reflecting the characteristics of the user information, but the present disclosure is not limited thereto. For example, incomplete and/or not initiated tasks may also be provided as materials in a to-do item format.

FIGS. 13 through 15 illustrate interfaces for providing generated items and related history information according to some embodiments of the present disclosure.

According to some embodiments of the present disclosure, generative AI may recommend and/or generate materials for task generation/processing based on user information and provide them in the form of widgets. Recommended/generated tasks and/or generated products may also be stored in a database for later use as materials. In other words, materials in the present disclosure may refer to content directly generated by generative AI, content generated by combining previously generated content, materials and/or data selected/input by the user, and/or content generated based on these elements. If the materials have been recommended/generated by generative AI, the user may click/tap on the widget of each material element to check the generation history (e.g., what material elements were used for generation on specific dates or previous versions for any combined/regenerated material elements).

Referring to FIG. 13, each generated product created by generative AI may include an AI mark 1301a. For example, the user may click/tap content that includes the AI mark 1301a to check its generation history. If the user long-presses the AI mark 1301a on a video, a related video list 1301b may expand and appear. If the user clicks/taps a content item in the video list 1301b that includes an AI mark, the interface may transition to a detail page 1300c that contains history information for the clicked/tapped content item.

The detail page 1300c for a generated product may include the generated product's generation date and generation record (e.g., version, previously generated products used as a basis for the current product, material list by service, etc.). For example, on a detail page for video content with an AI mark, the user may check the video content's generation record (e.g., version, previously generated video content used in the creation of the current video content, materials by service, such as meeting, email, messenger, and collaboration tool, etc.) for each date. Additionally, the version of the generated product and/or material on the detail page 1300c may be indicated on the corresponding generated product and/or material with a mark (e.g., v2.1, v2.2, v3.0, etc.).

Furthermore, if modifications to the generated product on the detail page 1300c are necessary, the user may retrieve the generated product's previous version, and may regenerate the content by recombining it with the materials included in the generation record on the detail page 1300c and/or with other materials.

The version of a generated product may distinguish between the original generated product and a regenerated product that has been created through the recombination of some or all of the materials used in the original generated product.

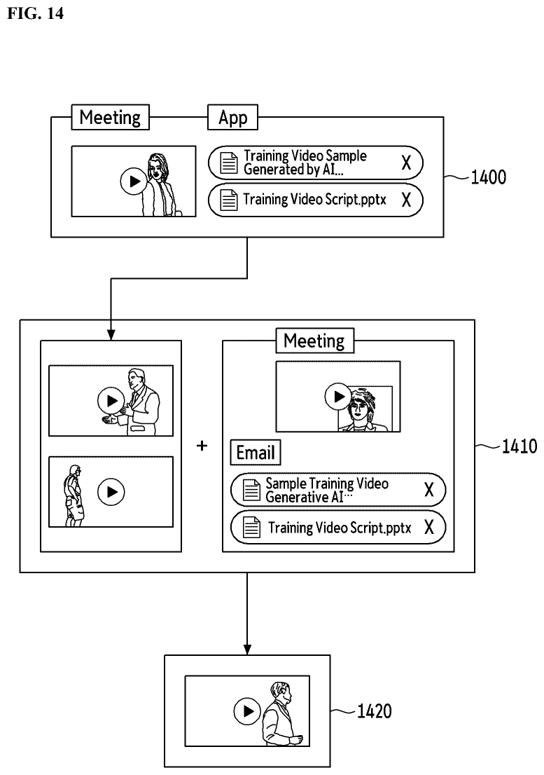

FIG. 14 is a diagram illustrating the versioning system for generated content. Referring to FIG. 14, an original first generated product 1400 may be recombined with multiple other materials, and may thereby be regenerated as a second generated product 1410 in a new version. Additionally, the second generated product 1410 may be recombined with multiple other materials and may thereby be regenerated as a third generated product 1420 in another new version. The first, second, and third generated products 1400, 1410, and 1420 may be stored in a database by generation date and provided to the user in various formats. For example, on the detail page 1300c in FIG. 13, the user may check generated products and materials used for the generated products by date and/or version.

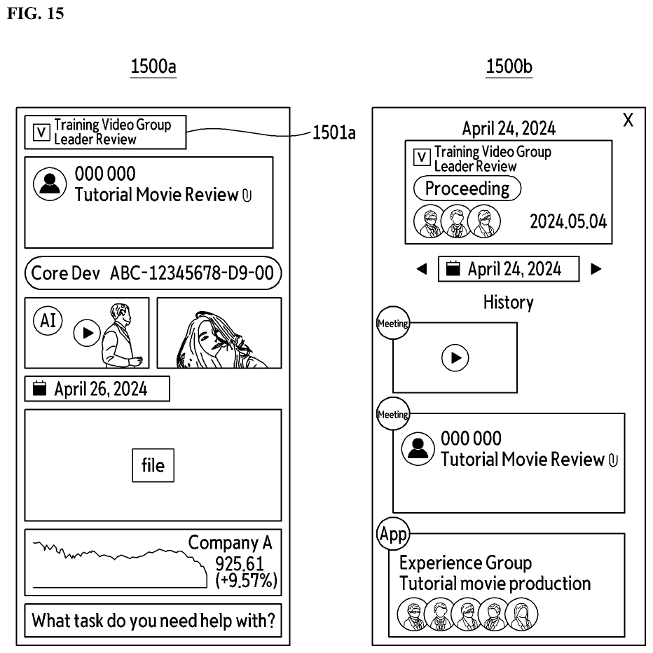

Referring to FIG. 15, according to some embodiments of the present disclosure, generative AI may generate and display to-do item-type materials 1501a based on user information, and may also provide history information for the to-do item-type materials. The to-do item-type materials 1501a included in new task generation page 1500a may be provided in the form of widgets.

For example, the user may click/tap one of the to-do item-type materials generated and provided based on the user information to navigate to a detail page 1500b for the selected to-do item-type material. The detail page 1500b may include specific details of the selected to-do item-type material and/or history information for the selected to-do item-type material. For example, the history information may be provided by date and may include content summarized/generated by generative AI for each service (e.g., collaboration tool, messenger, email, SNS, etc.) related to the selected to-do item-type material.

Here, the to-do item-type materials may refer to tasks generated/processed according to some embodiments of the present disclosure, and the history information may refer to task history information related to the to-do-type materials. As described above, the to-do-type materials and related history information may be used as materials by generative AI according to some embodiments of the present disclosure.

In other words, generative AI may generate widgets for to-do items based on task generation/processing records according to some embodiments of the present disclosure. When the user clicks/taps each widget, related information such as information such as any associated meeting, email, messenger, or collaboration tool may be summarized by date, and history information may be generated by summarizing the user's task execution information. Furthermore, according to some embodiments of the present disclosure, generative AI may summarize and then automatically link task records acquired during task generation/processing to the widgets for the respective to-do items.

The new task generation page 1500a in FIG. 15 may correspond to the page 1300a in FIG. 13.

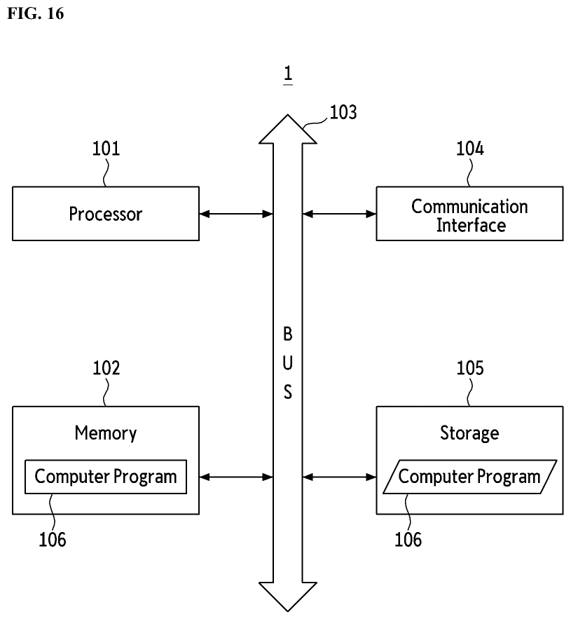

FIG. 16 is an illustrative hardware configuration diagram illustrating the computing device 1.

Referring to FIG. 16, the computing device 1 may include at least one processor 101, a system bus 103, a communication interface 104, a memory 102, which loads a computer program 106 executed by the processor 101, and a storage 105, which stores the computer program 106. Even though FIG. 16 depicts only components related to the embodiments of the present disclosure, it is obvious to one of ordinary skill in the art to which the present disclosure pertains that the computing device 1 may further include other generic components, in addition to the components depicted in FIG. 16. Moreover, in some embodiments, the computing device 1 may be configured with some of the components depicted in FIG. 16 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

For example, the processor 101 may perform task management based on a generative AI model. Specifically, the processor 101 may generate a task list according to user information based on the generative AI model, and may process one or more tasks included in the task list without requiring the user's prompt input. In another example, the processor 101 may generate a plurality of items related to at least one task based on a generative AI model, receive a selection for at least one of the generated items from the user, and compose a prompt requesting task processing by inputting the selected item(s) into the generative AI model.

In Addition, the computing device 1 may further include database, and the processor 101 may store data and/or information generated/output according to some embodiments of the present disclosure in the memory 102 and/or a database. Here, the database in which the data and/or information is stored is not limited to the database included in the computing device 1, and may include, for example, a database of external server.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

For example, the computer program 106 may include instructions for the operations of: generating a task list by inputting user information of a user into a first model, the task list including a plurality of tasks expected to be processed by the user; generating a plurality of items related to the plurality of tasks by inputting the user information into the first model; receiving, from the user, a selection of a task to be processed from among the plurality of tasks; receiving, from the user, a selection of an item related to the selected task from among the plurality of items; composing a first prompt by inputting the selected item into a second model, the first prompt requesting the selected task to be processed based on the selected item; and outputting a processing result for the selected task by inputting the first prompt into a third model.

The task management methods, apparatuses, and/or systems according to the present disclosure comprehensively utilize user information, such as personal information and task service data, to automatically generate and utilize tasks, generation materials, and task history based on generative AI. According to the present disclosure, tasks may be generated based on generative AI, allowing the user's required tasks to be derived and generated in advance without the user's prompt text key-in. Additionally, according to the present disclosure, the user may be provided, if necessary, with materials required for prompt input based on user information, enabling rapid prompt composition and result generation without requiring the user's prompt text key-in.

Various embodiments of the present disclosure and their effects have been described so far with reference to FIGS. 1 through 16.

It should be noted that the effects of the present disclosure are not limited to those described above, and other effects of the present disclosure will be apparent from the following description.

The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for task management performed by a computing device, the method comprising:
generating a task list by inputting user information of a user into a first model, the task list including a plurality of tasks expected to be processed by the user;
generating a plurality of items related to the plurality of tasks by inputting the user information into the first model;
receiving, from the user, a selection of a task to be processed by the user from among the plurality of tasks;
receiving, from the user, a selection of an item related to the selected task from among the plurality of items;
composing a first prompt by inputting the selected item into a second model, the first prompt requesting the selected task to be processed based on the selected item; and
outputting a processing result for the selected task by inputting the first prompt into a third model.

2. The method of claim 1, further comprising:
receiving, from the user, a selection of at least one item from among the plurality of items;
generating a task by inputting the at least one selected item into a fourth model; and
adding the generated task to the task list.

3. The method of claim 1, wherein
the selected item is a first item,
the method further comprises:
receiving, from the user, an input of a second item which is different from the first item and is related to the selected task, and
the composing the first prompt comprises:
composing the first prompt by additionally inputting the second item into the second model.

4. The method of claim 3, wherein the receiving the input of the second item related to the selected task comprises:
performing security or license authentication for the second item.

5. The method of claim 1, wherein the outputting the processing result for the selected task comprises:
determining a completion status of the selected task; and performing security or license authentication for the processing result.

6. The method of claim 1, wherein
the generating the task list comprises:
storing generation-related information for the plurality of tasks in a first database, and
the generating the plurality of items comprises:
storing generation-related information for the plurality of items in a second database.

7. The method of claim 1, wherein the outputting the processing result for the selected task comprises:
storing task processing information for the selected task in a third database.

8. The method of claim 1, wherein
the outputting the processing result for the selected task comprises:
generating a first generated product for the selected task by combining the selected item, and
the method further comprises:
receiving, from the user, a selection of the first generated product and at least some of the plurality of items; and
generating a second generated product corresponding to the selected task by inputting the at least some selected items into the second model and recombining the first generated product with the at least some selected items, using a result output from the second model.

9. The method of claim 1, further comprising:
displaying history information related to the selected task,
wherein the history information related to the selected task includes an item used for creating a generated product corresponding to the selected task and version information of the generated product corresponding to the selected task.

10. A system for task management, the system comprising:
at least one processor; and
at least one memory configured to store instructions that, when executed by the at least one processor, cause the at least one processor to perform operations,
wherein the operations comprise:
generating a task list by inputting user information of a user into a first model, the task list including a plurality of tasks expected to be processed by the user;
generating a plurality of items related to the plurality of tasks by inputting the user information into the first model;
receiving, from the user, a selection of a task to be processed by the user from among the plurality of tasks;
receiving, from the user, a selection of an item related to the selected task from among the plurality of items;
composing a first prompt by inputting the selected item into a second model, the first prompt requesting the selected task to be processed based on the selected item; and
outputting a processing result for the selected task by inputting the first prompt into a third model.

11. The system of claim 10, wherein the operations further comprise:
receiving, from the user, a selection of at least one item from among the plurality of items;
generating a task by inputting the at least one selected item into a fourth model; and
adding the generated task to the task list.

12. The system of claim 10, wherein
the selected item is a first item,
the operations further comprise:
receiving, from the user, an input of a second item which is different from the first item and is related to the selected task, and
the composing the first prompt comprises:
composing the first prompt by additionally inputting the second item into the second model.

13. The system of claim 12, wherein the receiving the input of the second item related to the selected task comprises:
performing security or license authentication for the second item.

14. The system of claim 10, wherein the outputting the processing result for the selected task comprises:
determining a completion status of the selected task; and performing security or license authentication for the processing result.

15. The system of claim 10, wherein
the generating the task list comprises:
storing task generation-related information for the plurality of tasks in a first database, and
the generating the plurality of items comprises:
storing item generation-related information for the plurality of items in a second database.

16. The system of claim 10, wherein the outputting the processing result for the selected task comprises:
storing task processing information for the selected task in a third database.

17. The system of claim 10, wherein
the outputting the processing result for the selected task comprises:
generating a first generated product for the selected task by combining the selected item, and
the operations further comprise:
receiving, from the user, a selection of the first generated product and at least some of the plurality of items; and
generating a second generated product corresponding to the selected task by inputting the at least some selected items into the second model and recombining the first generated product with the at least some selected items, using a result output from the second model.

18. The system of claim 10, wherein
the operations further comprise:
displaying history information related to the selected task, and
the history information related to the selected task includes an item used for creating a generated product corresponding to the selected task and version information of the generated product corresponding to the selected task.

19. A non-transitory computer-readable recording medium storing a computer program, which, when executed by at least one processor, causes the at least one processor to perform:
generating a task list by inputting user information of a user into a first model, the task list including a plurality of tasks expected to be processed by the user;
generating a plurality of items related to the plurality of tasks by inputting the user information into the first model;
receiving, from the user, a selection of a task to be processed by the user from among the plurality of tasks;
receiving, from the user, a selection of an item related to the selected task from among the plurality of items;
composing a first prompt by inputting the selected item into a second model, the first prompt requesting the selected task to be processed based on the selected item; and
outputting a processing result for the selected task by inputting the first prompt into a third model.
